(19) United States
(12) Patent Application Publication
(10) Pub. No.: US 2010/0259791 A1
(43) Pub. Date: Oct. 14, 2010

(54) INK JET PRINTING APPARATUS AND PRINTING METHOD

(75) Inventors: Takuma HAYASHI, Shiojiri (JP); Toshiaki KAKUTANI, Shiojiri (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/758,378

(22) Filed: Apr. 12, 2010

(30) Foreign Application Priority Data
Apr. 14, 2009 (JP) 2009-098179
Jun. 18, 2009 (JP) 2009-145176

(51) Int. Cl. H04N 1/405

(52) U.S. Cl. 358/2.1

(57) ABSTRACT

Provided is an ink jet printing apparatus capable of printing halftone image data representing a halftone image including at least color components of cyan, magenta, and yellow, the ink jet printing apparatus including: an input unit which is used to input the halftone image data; a smoothing unit which creates smoothing image data by performing a smoothing process only on the yellow component in the halftone image data or performing a smoothing process having a smoothing degree relatively stronger than those of other color components on the yellow component; and a printing control unit which controls execution of a printing process on the basis of the smoothing image data.

### CROSS REFERENCES TO RELATED APPLICATIONS

The entire disclosure of Japanese Patent Application Nos: 2009-098179, filed Apr. 14, 2009 and 2009-145176, filed Jun. 18, 2009 are expressly incorporated by reference herein.

### BACKGROUND

1. Technical Field

The present invention relates to a printing technology using an ink jet printing apparatus of halftone image data representing a halftone image including at least color components of cyan, magenta, and yellow.

2. Related Art

In a screen printing process, a correction (proof) operation of checking a color tone of a printing object, whether a character is correct or incorrect, a position of an image, and the like is performed before a final printing process. However, in order to perform a cheap and easy correction operation, a technology of performing the correction operation using a printing object output by an ink jet printer has been demanded (for example, refer to JP-A-2001-144959). In the case where the correction operation is performed by using the ink jet printer, it is necessary to realize a halftone dot which is approximate to an output result of an offset printing process.

Among halftone data for the offset printing process, in order to suppress an occurrence of a moire caused by an interference of a halftone dot, in many cases, a halftone screen angle of each of colors of cyan C, magenta M, yellow Y, and black K (hereinafter, simply referred to as C, M, Y, and K) is set such that the C is 15°, the M is 45°, the Y is 0°, and the K is 75°. That is, in the case of the C, M, and K, a screen angle difference is ensured therebetween by 30°. In the case where halftone data of different screen angles overlap, a region having a large overlap ratio of the halftone dot and a region having a small overlap ratio thereof are generated at a predetermined cycle. However, when the screen angle is small, the generation period becomes long (becomes a low spatial frequency), and hence a moire is easily noticed. On the other hand, in the case of the Y, the Y is hardly noticed compared with other colors, and is hardly noticed even when a moire of other color components is generated. For this reason, a priority of suppressing the moire is relatively decreased, so that the screen angle difference between the C and K is 15°.

In the case where the halftone data is output by using the ink jet printer, a particular problem arises in the ink jet printer. The problem will be described with reference to FIGS. 10A to 10I. FIGS. 10A to 10C conceptually illustrate image data corresponding to the screen angles of the C, Y, and M. The screen angles of color components are described above. FIG. 10D illustrates data of the C and Y in the case where green is displayed from the C and Y. In the drawings, the data of the Y is depicted by a dotted line. FIG. 10E illustrates data of the Y and M in the case where red is displayed from the Y and M. In the drawings, the data of the Y is depicted by a dotted line.

FIG. 10F illustrates a state where the overlap portion of the data of the C and Y shown in FIG. 10D is emphasized in black. As shown in the drawing, since the screen angle difference (15°) between the C and Y is small, the C and Y overlap with each other at a low period, and hence it is understood that the overlap portion is generated at the same interval. On the other hand, FIG. 10G illustrates a state where the overlap portion of the data of the Y and M shown in FIG. 10E is emphasized in black. As shown in the drawing, since the screen angle difference) (45°) between the Y and M is large, the Y and M overlap with each other at a high period, and hence it is understood that the overlap portion is not noticed at the same interval.

The results obtained by outputting green and red image data using the ink jet printer are shown in FIGS. 10H and 10I. FIG. 10H is the output result of the green image, and a moire is noticed in accordance with the overlap period. FIG. 10I is the output result of the red image, and a moire of the overlap portion is not noticed. Likewise, in the offset printing process, the unnoticed moire involved with the Y becomes the noticed result in the output of the ink jet printer.

This phenomenon is caused by the limitation (hereinafter, referred to as a duty ratio limitation) of the ink amount which can be absorbed to a printing medium in the ink jet printer. In detail, in the ink jet printer, the substitution of usage ink due to the duty limitation is performed. In the substation of ink, for example, when input data is converted into each ink amount data by using a LUT, a background color removal is performed so as to substitute a part of the C, M, and Y with K ink. In addition, for example, in the printer including ink of light cyan Lc (hereinafter, simply referred to as Lc), Lc ink is mainly used in a printing region of C-based primary color, and Lc ink is substituted with C ink in a printing region of secondary color such as green or blue. In the case where the duty ratio is not satisfied even when the substitution of C ink is performed, the amount of C ink is decreased. By using the substitution of the ink, there are a region where the usage amount of C ink is small and a region where the usage amount of C ink is not small in accordance with the usage amount of Y ink even in the similar color. Likewise, in the ink jet printer, since the color configuration of the usage ink is locally and largely changed, the moire not noticed in the offset printing process may be noticed. Particularly, in the case of the Y component, since the Y component has a small screen angle difference with respect to the other color components, the moire is noticed in many cases.

### SUMMARY

An advantage of some aspects of the invention is that it provides an ink jet printing apparatus and a printing method of allowing an output result of halftone image data using a correction ink jet printer to be approximate to a printing result of a screen printing process.

At least a part of the above-described object is realized by the following embodiments or applications.

### Application 1

There is provided an ink jet printing apparatus capable of printing halftone image data representing a halftone image including at least color components of cyan, magenta, and yellow, the ink jet printing apparatus including: an input unit which is used to input the halftone image data; a smoothing unit which creates smoothing image data by performing a smoothing process only on the yellow component in the halftone image data or performing a smoothing process having a smoothing degree relatively stronger than those of other color components on the yellow component; and a printing control unit which controls execution of a printing process on the basis of the smoothing image data.

In the ink jet printing apparatus having the above-described configuration, when the smoothing process is performed only on the yellow component among the halftone image data subjected to the multi-level process and the resolution converting process, it is possible to allow the moire involved with the yellow component not to be noticed by relatively decreasing a variation amount for each pixel of the yellow component. In addition, when the smoothing process is performed on all color components, and the relatively strong smoothing process is performed on the yellow component, it is possible to allow the moire of each of the color components not to be noticed as in the offset printing process. As a result, the output result using the ink jet printing apparatus may be approximate to the printing result of the screen printing process.

### Application 2

The ink jet printing apparatus according to application 1 further includes: a character detection unit which detects character data forming a character portion of the image represented by the halftone image data, wherein the smoothing unit performs the smoothing process by excluding the character data detected by the character detection unit from a target of the smoothing process.

In the ink jet printing apparatus having the above-described configuration, since the character portion is excluded from the target of the smoothing process, it is possible to prevent a problem that the character portion is vaguely output. As a result, it is possible to allow the output result of the ink jet printing apparatus to be approximate to the printing result of the screen printing process without deteriorating the image quality of the character portion.

### Application 3

The ink jet printing apparatus according to application 1 or 2 further includes: an edge detection unit which detects edge data forming an edge portion of the image represented by the halftone image data, wherein the smoothing unit performs the smoothing process by excluding the edge data detected by the edge detection unit from a target of the smoothing process.

In the ink jet printing apparatus having the above-described configuration, since the edge portion is excluded from the target of the smoothing process, it is possible to prevent a problem that the edge portion is vaguely output. As a result, it is possible to allow the output result of the ink jet printing apparatus to be approximate to the printing result of the screen printing process without deteriorating the image quality of the edge portion.

### Application 4

In the ink jet printing apparatus according to any one of application 1 to application 3, the smoothing unit changes a smoothing degree for the target pixel in accordance with an area ratio of a halftone dot in a peripheral pixel of the target pixel of the smoothing process.

In the ink jet printing apparatus having the above-described configuration, since the smoothing degree is changed in accordance with the area ratio of the halftone dot of the peripheral pixel, it is possible to perform the smoothing process in accordance with a degree that the moire caused by the area ratio is easily noticed. As a result, it is possible to reduce the notice degree of the moire caused by the characteristic of the ink jet printing apparatus in accordance with the degree that the moire is easily noticed by maximally maintaining the printing result of the screen printing process.

### Application 5

In the ink jet printing apparatus according to application 4, the smoothing unit allows the smoothing degree for the yellow component of the target pixel to be relatively strong when the area ratio is within an intermediate degree of a predetermined range.

In the ink jet printing apparatus having the above-described configuration, since the smoothing degree for the yellow component is relatively strong in a region having an intermediate degree of an area ratio in which the moire easily occurs.

### Application 6

In the ink jet printing apparatus according to any one of application 1 to application 5, the smoothing unit changes a smoothing degree for the target pixel in accordance with a magnitude of a grayscale value of each color component in a peripheral pixel of the target pixel of the smoothing process.

In the ink jet printing apparatus having the above-described configuration, since the smoothing degree is changed in accordance with the magnitude of the grayscale value of each color component of the peripheral pixel, it is possible to perform the smoothing process in accordance with the degree that the moire caused by the magnitude of the grayscale value occurs. As a result, it is possible to reduce the notice degree of the moire caused by the characteristic of the ink jet printing apparatus in accordance with the degree that the moire is easily noticed by maximally maintaining the printing result of the screen printing process.

### Application 7

In the ink jet printing apparatus according to application 6, the smoothing unit allows the smoothing degree for the yellow component of the target pixel to be relatively strong when a grayscale value of a minimum angle color component is larger than a predetermined value, the minimum angle color component being a color component having the smallest screen angle difference with respect to the yellow component among the yellow component in the peripheral pixel and/or the color components of the halftone image data.

In the ink jet printing apparatus having the above-described configuration, since the smoothing degree for the yellow component is relatively strong in a region where the grayscale value of the yellow component and/or the minimum angle color component is large, and the moire involved with the yellow component is easily noticed, it is possible to effectively allow the moire involved with the yellow component not to be noticed.

### Application 8

In the ink jet printing apparatus according to any one of application 1 to application 7, the smoothing unit performs the smoothing process of the yellow component at a smoothing degree randomly selected from a plurality of types of predetermined smoothing degrees.

In the ink jet printing apparatus having the above-described configuration, since it is possible to randomly change the smoothing degree, it is possible to suppress an occurrence of the moire.

### Application 9

In the ink jet printing apparatus according to any one of application 1 to application 8, the smoothing unit performs the smoothing process having a smoothing degree relatively stronger than those of other color components on the yellow component; and the smoothing unit allows a smoothing degree of the smoothing process performed on a minimum angle color component to be relatively stronger than that of a color component obtained by excluding the minimum angle color component from the other color components, the minimum angle color component being a color component having the smallest screen angle difference with respect to the yellow component among the color components of the halftone image data.

In the ink jet printing apparatus having the above-described configuration, since the smoothing degree of the smoothing process performed on the minimum angle color component is relatively stronger than that of a color component obtained by excluding the minimum angle color component and the yellow component from the color components of the halftone image data, it is possible to increase an advantage of suppressing the moire involved with the yellow component from being noticed.

### Application 10

The ink jet printing apparatus according to any one of application 1 to application 9 further includes: a multi-level and resolution converting unit which creates conversion image data by converting the input halftone image data into multi-levels and converting a resolution of the halftone image data into an output resolution of the printing apparatus, wherein the smoothing unit treats the conversion image data as the halftone image data to be subjected to the smoothing process.

Since the printing apparatus having the above-described configuration performs the smoothing process after performing the multi-level process and the resolution converting process on the input halftone image data, even when the halftone image data having any resolution is input, it is possible to perform the printing process.

Further, the aspect of the invention may be realized by a printing method of performing a printing process using the printing apparatus, a printing program, a storage medium for storing the program, and the like in addition to the configuration of the printing apparatus.

### BRIEF DESCRIPTION OF THE DRAWINGS

The invention will be described with reference to the accompanying drawings, wherein like numbers reference like elements.

FIG. 1 is a schematic configuration diagram illustrating a printing system.

FIG. 2 is a schematic configuration diagram illustrating a computer as a printing control device constituting the printing system.

FIG. 3 is a schematic configuration diagram illustrating a printer constituting the printing system.

FIG. 4 is a flowchart illustrating a sequence of a printing process of halftone data.

FIGS. 5A and 5B are explanatory diagrams illustrating halftone data and converted CMYK multi-grayscale data.

FIG. 6 is an explanatory diagram illustrating a sequence of a smoothing process.

FIGS. 7A to 7D are explanatory diagrams illustrating specific examples of a smoothing filter.

FIGS. 8A to 8D are explanatory diagrams illustrating modified examples of the smoothing filter.

FIGS. 9A to 9D are explanatory diagrams illustrating an advantage of the invention.

FIGS. 10A to 10I are explanatory diagrams illustrating a problem to be solved by the invention.

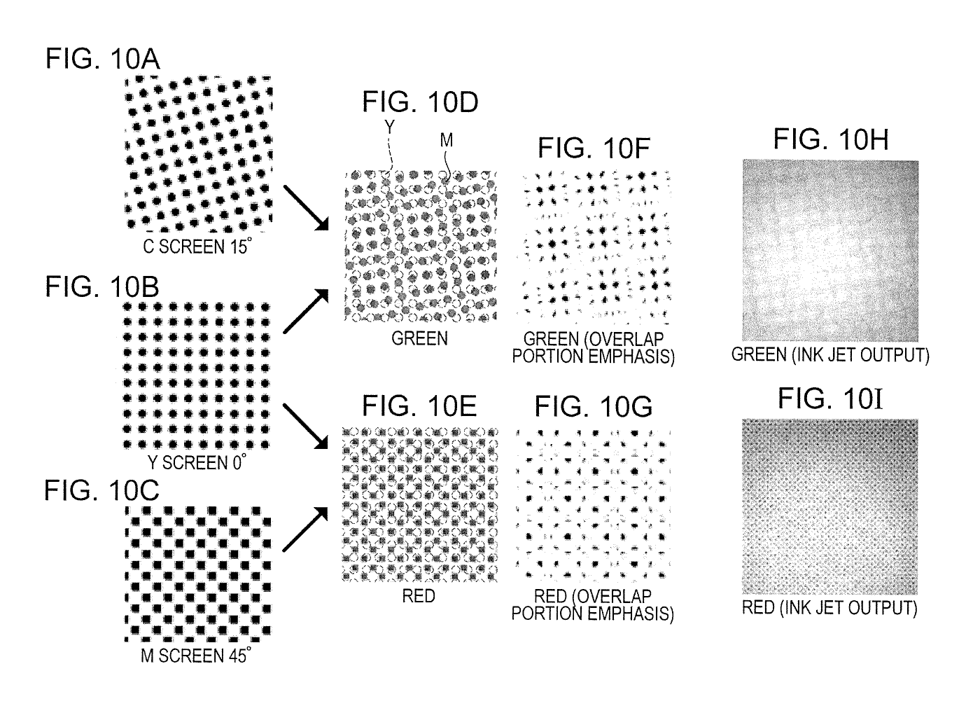

### DESCRIPTION OF EXEMPLARY EMBODIMENTS

### A. First Embodiment

A first embodiment of the invention will be described.

### A-1. Configuration of Apparatus

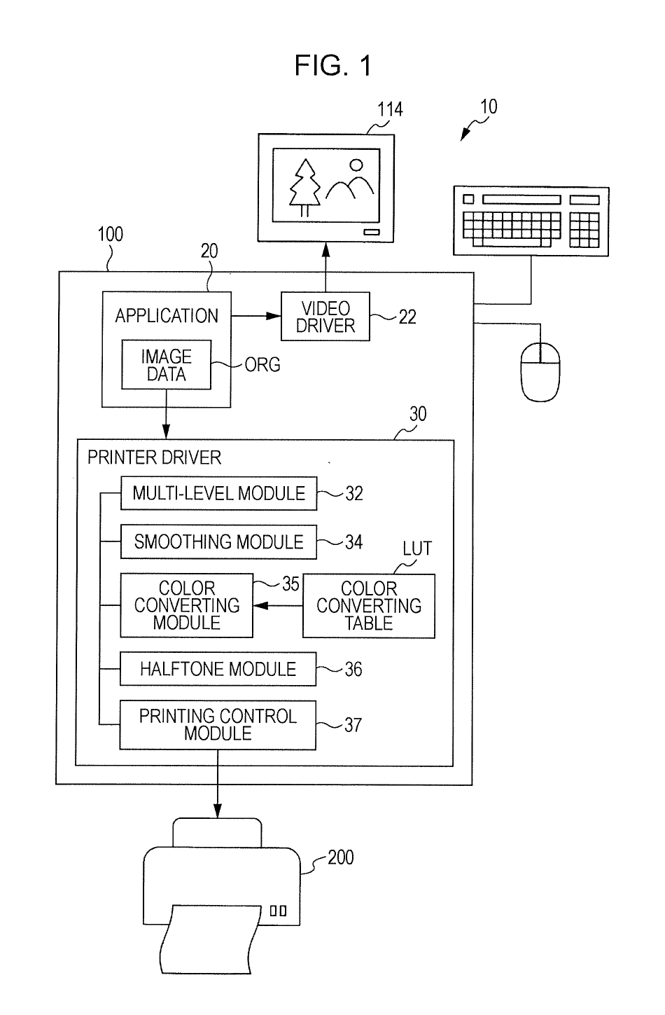

FIG. 1 is a schematic configuration diagram of a printing system 10 according to an embodiment of the invention. A printing system 10 according to the embodiment is a printing system for correcting halftone image data for an offset printing process, and includes a computer 100 which is a printing control device, a printer 200 which actually prints an image under the control of the computer 100, and the like as shown in the drawings. The printing system 10 serves as an extensive printing apparatus by integrating all the constituents. In addition, the printing system 10 may print multi-grayscale data.

The printer 200 according to the embodiment includes color ink, that is, cyan ink, magenta ink, yellow ink, black ink, light cyan ink, and light magenta ink.

A predetermined operating system is installed in the computer 100, and an application program 20 is operated in the operating system. A video driver 22 or a printer driver 30 is assembled in the operating system. When image data ORG is input, the application program 20 displays the image obtained by the image data ORG on a display 114 through the video driver 22. In addition, the application program 20 outputs the image data ORG to the printer 200 through the printer driver 30.

In the embodiment, the image data ORG input by the application program 20 is binary halftone image data which is formed by four colors of color components (C, M, Y, and K) and is created for an offset printing process. The screen angles of the color components are set such that C is 15°, M is 45°, Y is 0°, and K is 75°. The halftone image data may be created by, for example, a RIP (Raster Image Processor) or the like. In addition, the image data ORG may include four colors or more of color components including C, M, and Y, and may include, for example, a color component such as orange or green. In addition, the screen angles of the color components are not limited to the above-described example. For example, C may be 15°, M may be 75°, Y may be 0°, and K may be 45°.

The printer driver 30 includes a multi-level module 32, a resolution converting module 33, a smoothing module 34, a color converting module 35, a halftone module 36, and a printing control module 37.

The multi-level module 32 creates multi-grayscale image data by changing the input binary image data ORG into multi-level image data. The resolution converting module 33 converts the multi-level image data ORG into image data having an output resolution of the printer 200. The smoothing module 34 performs a smoothing process on the color components of the image data ORG having the converted resolution. The color converting module 35 converts C, M, Y, and K as the color components of the image data ORG subjected to the smoothing process in accordance with a predetermined color converting table LUT into color components of C, M, Y, K, light cyan Lc, and light magenta Lm which can be displayed by the printer 200.

The halftone module 36 performs a halftone process in which the grayscale dot of the image data subjected to the color converting process of the color converting module 35 is displayed by a distribution of a dot. In this example, the halftone process is performed by using a generally known dither method, but an error diffusion method, a concentration pattern method, or other halftone technologies may be used. The printing control module 37 rearranges the data arrangement of the image data subjected to the halftone process in accordance with a sequence to be transmitted to the printer 200, and outputs the resultant as printing data to the printer 200. Also, the printing control module 37 outputs various commands such as a printing start command or a printing end command to the printer 200, thereby controlling the printer 200.

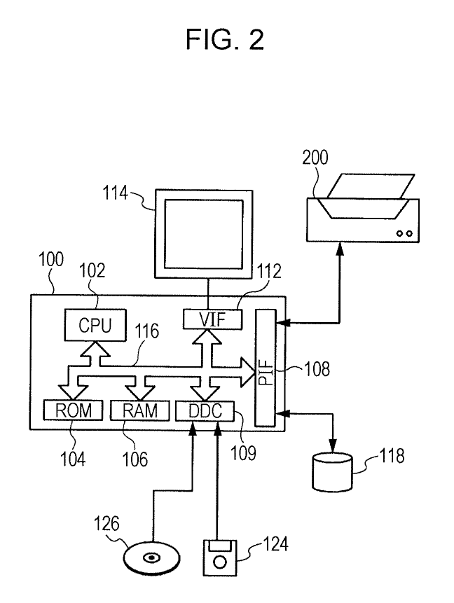

FIG. 2 is a configuration diagram of the computer 100 which is a printing control device. The computer 100 is a generally known computer which has a configuration in which a ROM 104, a RAM 106, or the like is connected to a bus 116 on the basis of a CPU 102.

The computer 100 is connected to a disk controller 109 which reads data of a flexible disk 124 or a compact disk 126, a peripheral device interface 108 which sends or receives data to or from a peripheral device, and a video interface 112 which drives a display 114. The peripheral device interface 108 is connected to the printer 200 or the hard disk 118. When the image data to be printed is input, the computer 100 performs the printing process of the image data by controlling the printer 200 through a function of the above-described printer driver 30.

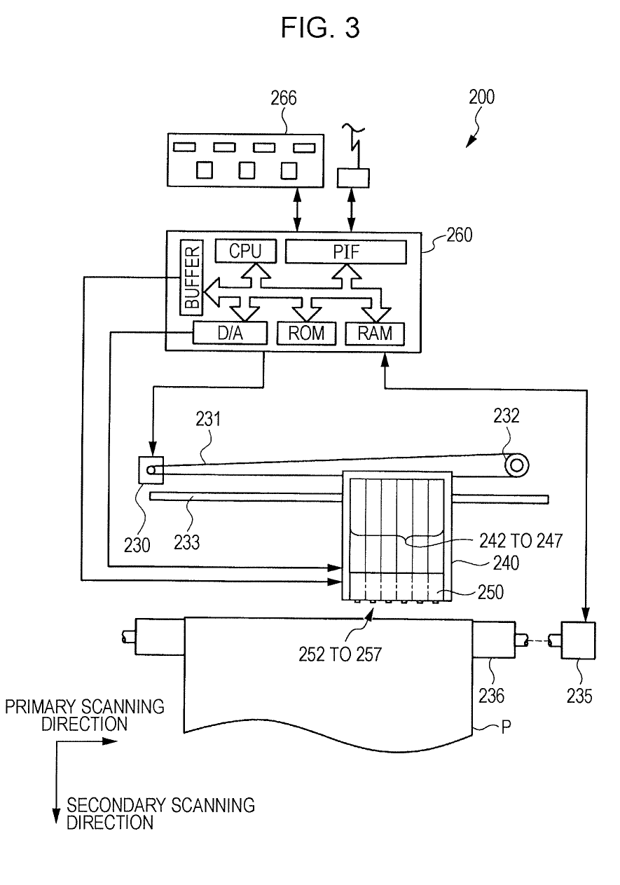

FIG. 3 is a configuration diagram of the printer 200. As shown in FIG. 3, the printer 200 includes a mechanism which transports a printing medium P by using a sheet transporting motor 235, a mechanism which reciprocating a carriage 240 in the axial direction of a platen 236 by using a carriage motor 230, a mechanism which ejects ink or forms a dot by driving a printing head 250 mounted to the carriage 240, and a control circuit 260 which is in charge of exchanging signals with the sheet transporting motor 235, the carriage motor 230, the printing head 250, and an operation panel 266.

The mechanism which reciprocating the carriage 240 in the axial direction of the platen 236 includes a sliding shaft 233 which is provided in parallel to the shaft of the platen 236 and slidably supports the carriage 240, a pulley 232 which allows an endless driving belt 231 to be suspended thereon together with the carriage motor 230, and the like.

The carriage 240 is mounted with ink cartridges 242 to 247 which respectively store the above-described six colors of ink. The printing head 250 of the lower portion of the carriage 240 is provided with six types of nozzle rows 252 to 257 corresponding to the above-described colors of color ink. When the ink cartridges 242 to 247 are mounted to the carriage 240 from the upside thereof, ink is supplied from each of cartridges to each of the nozzle rows 252 to 257.

The control circuit 260 of the printer 200 has a configuration in which a CPU, a ROM, a RAM, a PIF (peripheral device interface), and the like are connected to each other, and controls a primary scanning operation and a secondary scanning operation of the carriage 240 by controlling the operations of the carriage motor 230 and the sheet transporting motor 235. In addition, when the printing data output from the computer 100 is received through the PIF, the control circuit 260 supplies a driving signal corresponding to the printing data to the printing head 250 in accordance with the movement of the primary scanning operation or the secondary scanning operation of the carriage 240, thereby driving each color of head.

The printer 200 having the above-described hardware configuration reciprocates the printing head 250 (the nozzle rows 252 to 257 for the respective colors) with respect to the printing medium P in the primary scanning direction by driving the carriage motor 230, and moves the printing medium P in the secondary scanning direction by driving the sheet transporting motor 235. The control circuit 260 forms an ink dot having an appropriate color at an appropriate position on the printing medium P by driving the nozzle at an appropriate timing on the basis of the printing data in accordance with the sheet transporting movement (the secondary scanning operation) of the printing medium or the reciprocating movement (the primary scanning operation) of the carriage 240. In this manner, the printer 200 is able to print a color image on the printing medium P. In addition, in the above-described configuration, each color of ink is stored in the cartridge attachably or detachably mounted to the printer 200, but a configuration may be adopted in which each color of ink is stored in an ink storage tank or the like separately provided from the printer 200, and the ink storage tank is connected to the printer 200. Alternatively, a configuration may be adopted in which each color of ink is stored in a storage tank integrated with the printer 200 so as not to be detached therefrom.

### A-2. Halftone Data Printing Process

The printing process of the halftone data of the above-described printing system 10 will be described. The halftone data printing process is a process in which the image data ORG as the halftone image data is printed by using the printing system 10. The halftone data printing process according to the embodiment is started when a user of the printing system 10 performs a printing process of the image data ORG. When the halftone data printing process is started, the computer 100 inputs the image data ORG (Step S410). In the embodiment, the resolution of the image data ORG is 2400 dpi, and the number of the screen lines is 150 lpi.

When the image data ORG is input, the computer 100 converts the input image data ORG into the image data of the output resolution of the printer 200 for each color component as the process of the multi-level module 32 (Step S420). In the embodiment, the output resolution of the printer 200 is 1440 dpi. Since the process is a generally known technology, the description thereof is omitted, but herein, a binary method is used. Likewise, when the resolution of the binary data is converted by using the binary method, the grayscale value obtained by the interpolation calculation becomes multi-level data. That is, the resolution converting process in Step S420 is to simultaneously perform the multi-level process and the resolution converting process. In the embodiment, the data subjected to the resolution converting process is normalized so as to create 8 bits of multi-level data. In addition, the resolution converting method is not particularly limited, but for example, a bicubic method or the like may be used. In addition, the multi-level method may be separately performed from the resolution converting process. In this case, a nearest neighbor method or the like may be used for the resolution converting process.

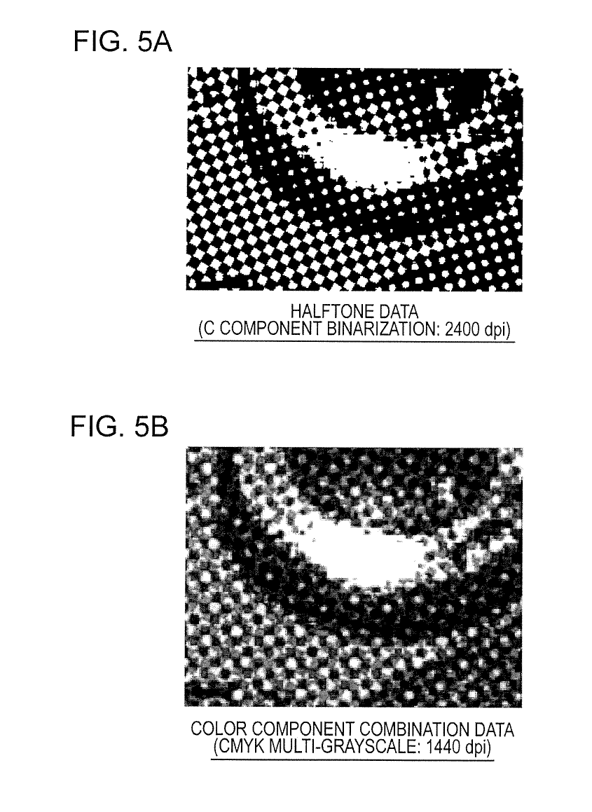

When the resolution converting process of the image data ORG is performed, the computer 100 combines the image data formed by a plurality of CMYK color components subjected to the resolution converting process (Step S430). In detail, the plurality of CMYK color components subjected to the multi-level process for each color component of the binary image is changed to the multi-level image including one CMYK color component value by adding the grayscale values of the same color component to each other. The detailed example of the image data obtained by combining the color components in this manner is shown in FIGS. 5A and 5B. FIG. 5A illustrates a C component of the binary image data ORG (binary halftone image data) input in Step S410.

On the other hand, FIG. 5B illustrates image data ORG (CMYK multi-grayscale) after combining color components in Step S430. As shown in the drawing, it is understood that the binary image data of the 1440 dpi has been subjected to the multi-grayscale process and the resolution converting process (1440 dpi) through Step S420 and Step S430.

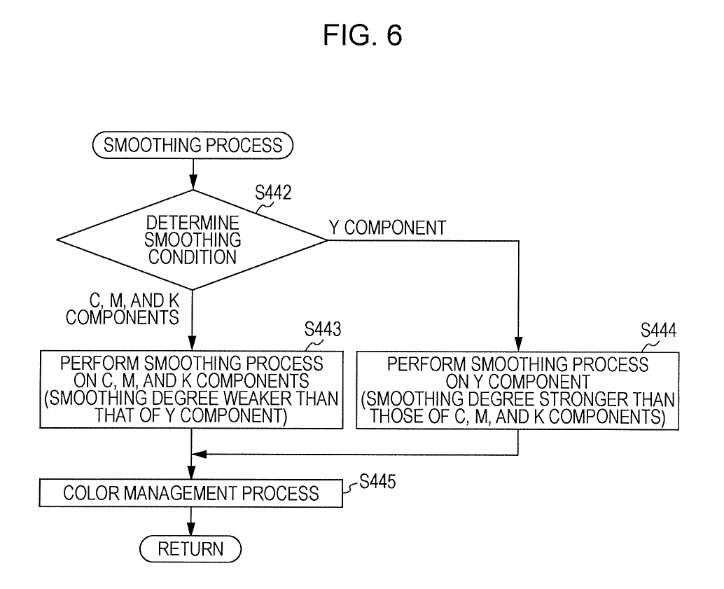

When the CMYK color components are combined, the computer 100 performs a smoothing process on the image data ORG obtained by combining the color components as the process of the smoothing module 34 (Step S440). The detailed description of the smoothing process will be made with reference to FIG. 6. In the smoothing process, first, the computer 100 determines the smoothing condition for each pixel on the basis of the image data ORG (Step S442). In the embodiment, the smoothing condition is to determine whether the smoothing process determined for each pixel of the image data ORG is performed. Here, the pixel forming the character portion of the image and the pixel forming the edge portion are not subjected to the smoothing process.

In the embodiment, in the determination whether it is a pixel forming the character portion, when the grayscale value of the determination target pixel is 100% of K component, it is determined that the determination target pixel is the pixel forming the character portion. In other cases, it is determined that it is not the pixel forming the character portion. The character portion is displayed as black in many cases. When such a determination is performed, it is possible to easily and promptly perform the determination.

In addition, in the determination whether it is a pixel forming the edge portion, the luminance value is calculated by using the CMYK component of each pixel so as to perform the edge detection of the corresponding luminance value. Accordingly, it is determined that the pixel having predetermined edge strength is the pixel forming the edge portion. In addition, since the edge detection is a generally known technology, the description thereof is omitted, but for example, various edge detecting filters such as a Sobel filter, a Prewitt filter, and a Roberts filter may be used.

When the smoothing condition is determined, the computer 100 performs the smoothing process on the C, M, and K components (Step S443) on the basis of the smoothing condition determined in Step S442, that is, the pixels determined to be subjected to the smoothing process in Step S442, and also performs the smoothing process on the Y component (Step S444). The smoothing process performed through Step S443 and Step S444 is a smoothing process in which the smoothing degree of the smoothing process performed on the Y component is stronger than those of the smoothing process performed on the C, M, and K components.

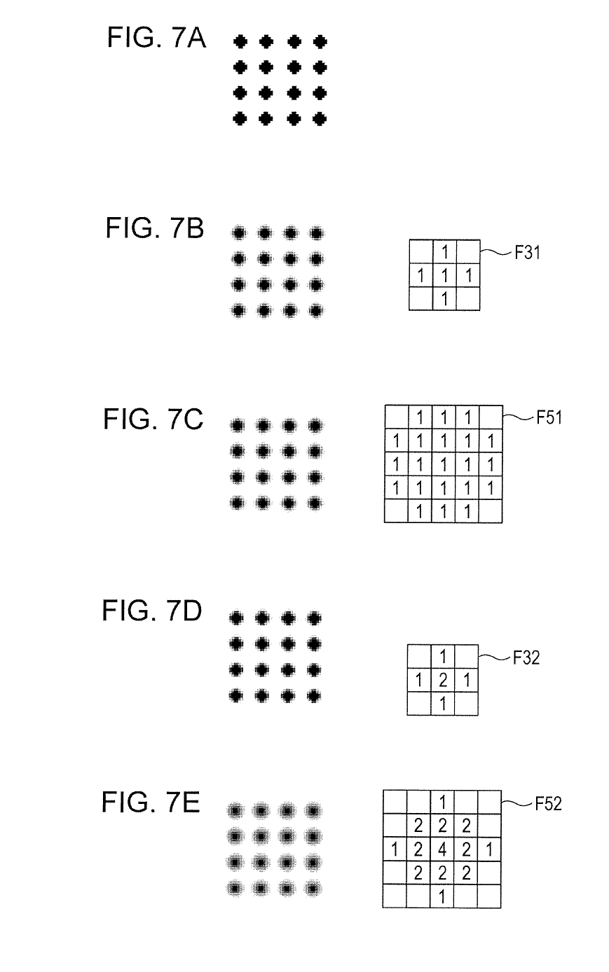

The smoothing process performed through Step S443 and Step S444 will be described further with reference to FIGS. 7A to 7D. FIG. 7A illustrates the output result of the image data before the smoothing process. In addition, a smoothing filter F31 is shown in FIG. 7B as a first example of the smoothing filter. The smoothing filter F31 is a smoothing filter having a size of 3 pixels by 3 pixels. The values of the elements (four elements) of four corners of the lattice shape of the smoothing filer F31 are 0 (where the 0 value is depicted as a blank in the drawing, and the same applies to the below), and the values of the other elements are 1.

The smoothing process using the smoothing filter F31 is performed in such a manner that the element located at the center of 9 elements forming the smoothing filter F31 is allowed to correspond to the smoothing target pixel, the values of the elements of the smoothing filter F31 are respectively multiplied by the grayscale values of the pixels at the positions respectively corresponding to the elements and are summed, and then the value obtained by removing the value by the sum value of the values of the elements is used as the grayscale value of the smoothing target pixel after the smoothing process. Hereinafter, the description is omitted, it is possible to obtain the grayscale value of the smoothing target pixel after the smoothing process by performing the same calculation on the other smoothing filters to be described later. The left drawing of FIG. 7B illustrates the output result when the smoothing process is performed by the smoothing filter F31, and it is understood that the image is smooth compared with FIG. 7A.

In addition, FIG. 7C illustrates a smoothing filter F51 as a second example of the smoothing filter. The smoothing filter F51 is a smoothing filer having a size of 5 pixels by 5 pixels. The values of the elements (four elements) of four corners of the lattice shape of the smoothing filter F51 are 0, and the values of the other elements are 1. The left drawing of FIG. 7C illustrates the output result when the smoothing process is performed by the smoothing filter F51, and it is understood that the smoothing degree becomes strong compared with FIG. 7B.

In addition, FIG. 7D illustrates a smoothing filter F32 as a third example of the smoothing filter. The smoothing filter F32 is a smoothing filter having a size of 3 pixels by 3 pixels. The values of the elements (four elements) of four corners of the lattice shape of the smoothing filter F32 are 0. The value of the element at the center of the lattice shape is 2, and the values of the other elements are 1. The left drawing of FIG. 7D illustrates the output result when the smoothing process is performed by the smoothing filter F32, and it is understood that the smoothing degree becomes weak compared with FIG. 7B.

In addition, FIG. 7E illustrates a smoothing filter F52 as a fourth example of the smoothing filter. The smoothing filter F52 is a smoothing filter having a size of 5 pixels by 5 pixels. The values of the elements (twelve elements) of four corners of the lattice shape of the smoothing filter F52 are 0, and the value of the center of the lattice shape is 4. The values of the elements become small in an order of 2 and 1 as it becomes farther from the center. The left drawing of FIG. 7E illustrates the output result when the smoothing process is performed by the smoothing filter F52, and it is understood that the smoothing degree becomes weak compared with FIG. 7C.

Likewise, the smoothing filter is able to change the smoothing degree by using the number of elements or the values of elements. As shown in the above-described four examples, the smoothing degree becomes strong as the number of elements increases. In addition, when the center element is set to a large value, the smoothing degree becomes weak. In Step S443 and Step S444, the smoothing process is performed so that the smoothing degree of the smoothing process performed on the Y component is relatively stronger than those of the smoothing process performed on the C, M, and K components by using the characteristic of the smoothing filter. In the embodiment, the smoothing process of the C, M, and K components is performed by using the smoothing filter F31, and the smoothing process of the Y component is performed by using the smoothing filter F51. In addition, the smoothing filter F31 or the smoothing filter F51 may be stored in the ROM 104 or the hard disk 118 of the computer 100, and may be read out in accordance with the smoothing condition for each pixel.

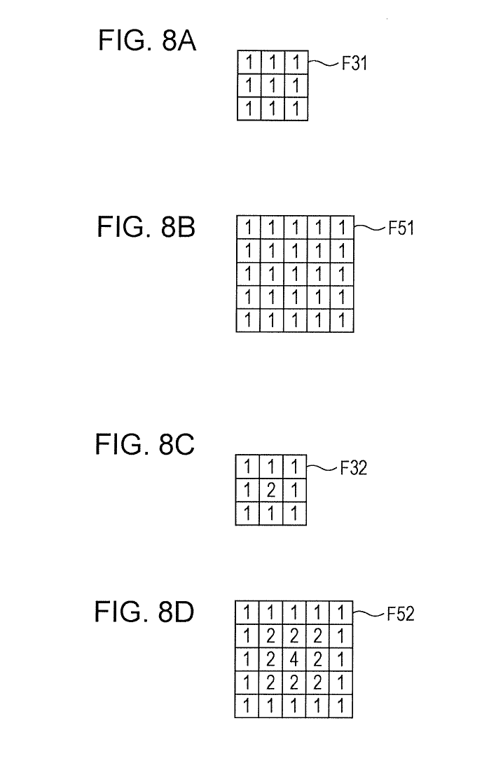

However, the values of the elements of the above-described smoothing filter are not particularly limited, and may be appropriately set. In addition, the values of the elements of four corners of the smoothing filter may be other than 0. For example, as shown in FIGS. 8A to 8D, the values of all elements of the smoothing filter may be other than 0. The reason why the values of the elements of the four corners are 0 as shown in FIGS. 7A to 7D is because the smoothing process is able to be performed in the state where the halftone shape is maintained compared with the case of FIGS. 8A to 8D.

Likewise, when the smoothing process is performed on each color component, the computer 100 performs a color management process (Step S445). The color management process is to perform a CMYK-CMYK converting process in accordance with a predetermined color converting table LUT in order to correct a difference between the color display characteristic of the offset printing apparatus and the color display characteristic of the printer 200. In this manner, it is possible to allow the output result of the printing system 10 to be approximate to the result of the offset printing process. However, Step S445 may be omitted. In this manner, when the color management process is performed, the smoothing process ends, and the computer 100 returns the current process to the halftone data printing process.

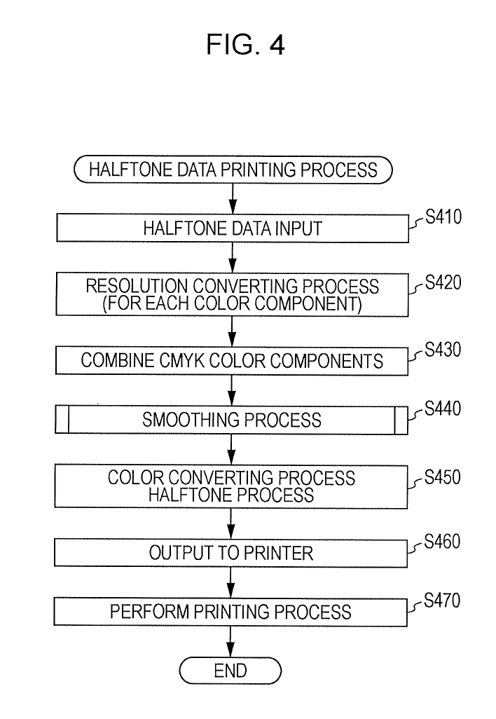

Here, the halftone data printing process of FIG. 4 will be described again. When the smoothing process is performed, the computer 100 performs the color converting process and the halftone process as the processes of the color converting module 35 and the halftone module 36 (Step S450). The process contents are described above. Then, the computer 100 rearranges the data arrangement of the image data subjected to the halftone process in accordance with a sequence to be transmitted to the printer 200 as the process of the printing control module 37 and outputs the resultant as the printing data to the printer 200. Also, the computer 100 outputs various commands such as a printing start command or a printing end command to the printer 200 (Step S460).

When the command is received, the printer 200 performs the printing process of the image data ORG by controlling the carriage motor 230, the sheet transporting motor 235, the printing head 250, and the like (Step S470). In this manner, the halftone data printing process ends.

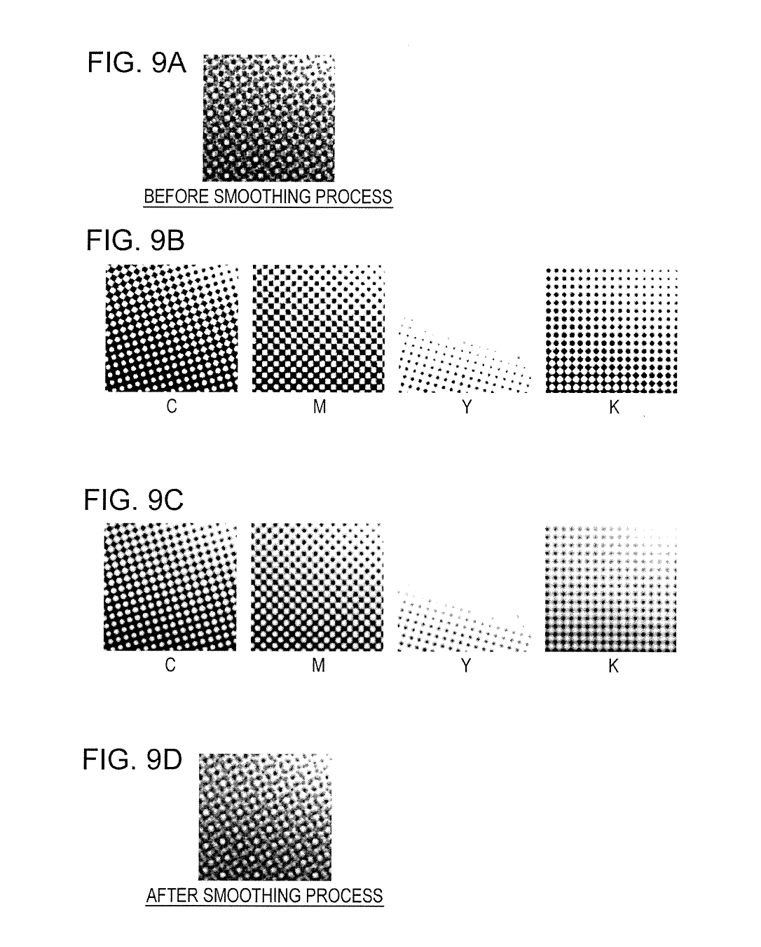

FIG. 9A illustrates the image data ORG in the case where the smoothing process of Step S440 is not performed in the halftone data printing process of the printing system 10. In addition, FIG. 9B illustrates the image data of each of the color components of the C, M, Y, and K in the case where the smoothing process is not performed. FIG. 9A is a diagram in which the color components of FIG. 9B are overlapped. On the other hand, FIG. 9C illustrates the image data of each of the color components of the C, M, Y, and K in the case where the smoothing process is performed. FIG. 9D illustrates the image data ORG in the case where the smoothing process is performed, and is a diagram in which the color components of FIG. 9C are overlapped. As shown in the drawing, when the smoothing process is performed so that the smoothing degree of the Y component is stronger than those of the C, M, and K components, the Y component is not relatively noticed.

### A-3. Advantage

Since the above-described printing system 10 performs the smoothing process on all color components in the halftone image data subjected to the multi-level process and the resolution converting process, it is possible to suppress a moire caused by the substitution of ink of the ink jet printer from being noticed by suppressing a local variation in ink amount. In addition, since the printing system 10 performs the smoothing process so that the smoothing degree of the Y component is stronger than those of the C, M, and K components, it is possible to suppress a variation in usage amount for each local area of the yellow ink, and thus to suppress a moire regarding the Y component caused by the substitution of ink of the ink jet printer from being noticed. As a result, it is possible to allow the output result of the printer 200 to be approximate to the printing result of the screen printing process.

In addition, since the printing system 10 does not perform the smoothing process on the character portion and the edge portion in the input image data ORG, it is possible to prevent a problem that the character portion or the edge portion is vaguely output. As a result, it is possible to allow the output result of the printer 200 to be approximate to the printing result of the screen printing process without deteriorating the image quality of the character portion or the edge portion.

### B. Second Embodiment

The halftone data printing process according to a second embodiment will be described. The printing system 10 according to the second embodiment has the same configuration as that of the first embodiment, but the contents of the halftone data printing process are different from those of the first embodiment. The halftone data printing process according to the second embodiment is different from that of the first embodiment in that the smoothing condition determined in Step S442 of the smoothing process is the smoothing degree determined for each pixel. In detail, it is different from the first embodiment in that the smoothing degree is changed in accordance with the area ratio of the halftone dot of the peripheral pixel of the determination target pixel. Hereinafter, only the point different from the first embodiment will be described.

In Step S442, the computer 100 first obtains the area ratio of the halftone dot of the peripheral pixel of the determination target pixel. Here, the range of the peripheral pixel is set to a range of 17 pixels by 17 pixels about the determination target pixel. It is because the periodic unevenness hardly occurs when the range of the peripheral pixel is set to a range close to the halftone pitch (2400 dpi/150 lpi=16 pixels). In addition, in the range of the peripheral pixel, when the number of pixels forms an odd square shape, the target pixel is located at the center thereof, and hence it is possible to remove a bias in four directions. However, the range of the peripheral pixel is not limited to the example, but may be appropriately set. In addition, the area ratio of the halftone dot is obtained in such a manner that the sum value of the grayscale values of the C, M, Y and K components of the peripheral pixel is removed by the sum value of the maximum value of the grayscale values of the C, M, Y, and K of the peripheral pixels. For example, in the case where each grayscale value of the C, M, Y, and K components is 256 grayscale of 0 to 255, and the grayscale value (C, M, Y, and K) of all pixels of 17 pixels by 17 pixels is 51, 51, 51, and 51, the area ratio is obtained such that {(51+51+51+51)×17×17}/{(255+255+255+255)×17×17}20%.

When the area ratio is obtained, the computer 100 determines the smoothing degree of the Y component corresponding to the area ratio. In detail, in the case where the area ratio is an intermediate degree (for example, a range equal to or more than 30% and equal to or less than 70%), the smoothing degree of the Y component of the determination target pixel is made to be stronger than the Y component of the other pixels. For example, when the smoothing filter shown in FIGS. 7A to 7D is exemplified, in the case of the target pixel having an intermediate degree of area ratio, the smoothing filter F51 is used for the smoothing process of the Y component, and the smoothing filter F31 is used for the smoothing process of the C, M, and K components. On the other hand, in the case of the target pixel having an intermediate degree (for example, a range equal to or more than 30% and equal to or less than 70%) of area ratio, the smoothing filter F52 having a smoothing degree weaker than that of the smoothing filter F51 is used for the smoothing process of the Y component, and the smoothing filter F31 is used for the smoothing process of the C, M, and K components. In addition, the threshold value of the area ratio of changing the smoothing degree may be set in consideration of the characteristic of the ink substitution of the LUT used in the printer 200.

Likewise, since it is possible to more strongly perform the smoothing process on the Y component in the intermediate grayscale region in which a moire is noticed, it is possible to increase an advantage of suppressing the moire from being noticed in accordance with the degree where the moire is easily noticed. In addition, in addition to the Y component, the smoothing degrees of the C, M, and K components may be changed. For example, in the case where the area ratio is an intermediate degree, the smoothing filter F31 may be used. In the case where the smoothing ratio is other than an intermediate degree, the smoothing filter F32 may be used. Accordingly, even in other color components, it is possible to increase an advantage of suppressing the moire from being noticed in accordance with the degree where the moire is easily noticed. In addition, the smoothing degree is not limited to the above-described two stage of variation, but may be changed in multi-stages in accordance with the area ratio. Further, the configuration according to the second embodiment may be combined with the configuration according to the first embodiment.

### C. Third Embodiment

The halftone data printing process according to a third embodiment will be described. The printing system 10 according to the third embodiment has the same configuration as that of the first embodiment, but the contents of the halftone data printing process are different from those of the second embodiment. In the halftone data printing process according to the third embodiment, Step S442 of the smoothing process is different from that of the second embodiment in that the smoothing degree is changed in accordance with the magnitude of the grayscale value of the color component of the peripheral pixel of the determination target pixel. Hereinafter, only the point different from the second embodiment will be described.

In Step S442, the computer 100 first obtains the sum value of the grayscale values of the C component and the Y component of the peripheral pixel of the determination target pixel. Here, the range of the peripheral pixel is set as in the second embodiment. Then, the computer 100 determines the smoothing degree of the Y component corresponding to the magnitude of the calculated sum value. In detail, in the case where the sum value is equal to or more than a predetermined value (for example, 128×17 pixels×17 pixels), the smoothing degree of the Y component of the determination target pixel is set to be stronger than that of the Y component of the other pixels. For example, when the smoothing filter shown in FIGS. 7A to 7D is exemplified, in the case of the target pixel having the sum value equal to or more than a predetermined value, the smoothing filter F51 is used for the smoothing process of the Y component, and the smoothing filter F31 is used for the smoothing process of the C, M, and K components. On the other hand, in the case of the target pixel having the sum value less than a predetermined value, the smoothing filter F52 is used for the smoothing process of the Y component, and the smoothing filter F31 is used for the smoothing process of the C, M, and K components. In addition, the reason why the C component is considered in addition to the Y component is because the screen angle difference between the C and Y is small (15°) as described above. In the case where the screen angle difference is different from the above-described example, the smoothing degree may be determined in consideration of the grayscale values of the Y component and the color component having the small screen angle difference with respect to the Y component.

Likewise, since it is possible to more strongly perform the smoothing process on the Y component in many regions of the C component and the Y component causing the moire which is easily noticed, it is possible to increase an advantage of suppressing the moire from being noticed in accordance with the degree where the moire is easily noticed. In addition, the determination reference for determining the smoothing degree is not limited to the sum value of the grayscale values of the C component and the Y component. In the case where at least one or both the grayscale values of the C component and the Y component are equal to or more than a predetermined value, the smoothing degree may be strong. In addition, in addition to the C component or the Y component, the smoothing degree may be changed in accordance with the magnitude of the grayscale value in the M and K components. For example, in the case where the grayscale value is equal to or more than a predetermined value, the smoothing filter F31 is used. In the case where the grayscale value is less than a predetermined value, the smoothing filter F32 may be used. Accordingly, even in other color components, it is possible to increase an advantage of suppressing the moire from being noticed in accordance with the degree where the moire is easily noticed. In addition, the smoothing degree is not limited to the above-described two stage of variation, but may be changed in multi-stages in accordance with the area ratio. Further, the configuration according to the third embodiment may be combined with the configuration according to the first embodiment and the configuration according to the second embodiment.

### D. Modified Examples

The modified examples of the above-described embodiments will be described.

### D-1. Modified Example 1

In the first embodiment, the smoothing degree of the Y component is uniform unless the target pixel forms the character portion and the edge portion. In the second embodiment or the third embodiment, the smoothing degree of the Y component is set to be uniform in accordance with the grayscale value or the area ratio of the halftone dot of the peripheral pixel. However, the smoothing degree may not necessarily be uniform, and the smoothing degree may be randomly selected from the predetermined smoothing degrees. For example, in the case of the first embodiment, the smoothing process may be performed on the Y component by using the smoothing filter randomly selected from plural filters having a smoothing degree stronger than that of the smoothing filter used for the C, M, and K components.

In addition, in the case of the second embodiment, the following configuration may be adopted. First, the computer 100 stores a first group including plural smoothing filters having a relatively strong smoothing degree, a second group including plural smoothing filters having an intermediate degree of a smoothing degree, and a third smoothing filter having a relatively weak smoothing degree. Then, in the case where the area ratio of the target pixel is an intermediate degree, the computer 100 performs the smoothing process on the Y component by using the smoothing filter randomly selected from the first group, and performs the smoothing process on the C, M, and K components by using the third smoothing filter. In addition, in the case where the area ratio of the target pixel is not an intermediate degree, the computer 100 performs the smoothing process on the Y component by using the smoothing filter randomly selected from the second group, and performs the smoothing process on the C, M, and K components by using the third smoothing filter. Further, although the description is omitted, the third embodiment may have the same configuration.

Likewise, when the smoothing degree is randomly changed so that the overlap state between the dot of the Y component and the dots of other color components is random, it is possible to suppress the occurrence of the moire involved with the Y component. In addition, even in the C, M, and K components, the smoothing process may be performed by using a smoothing filter randomly selected from plural smoothing filters having a relatively weak smoothing degree compared with the Y component.

### D-2. Modified Example 2

In the above-described embodiments, a configuration is shown in which the smoothing process is performed on all color components of the C, M, Y, and K, and the smoothing degree of the Y component is relatively stronger than those of the C, M, and K components, but the smoothing process may be performed on only the Y component. Even in this case, it is possible to efficiently suppress the moire involved with the Y component causing a big problem from being noticed.

In addition, a configuration may be adopted in which the smoothing process is performed only the Y component and the color component (hereinafter, referred to as a minimum angle color component and the C component in the embodiments) having the smallest screen angle difference with respect to the Y component. Even in this case, it is possible to suppress the moire involved with the Y component from being noticed. In addition, a configuration may be adopted in which the minimum angle color component is input to the computer 100 in accordance with the start operation of the user. In the case where header information of the image data ORG includes information on the screen angle, the minimum angle component may be read and recognized.

### D-3. Modified Example 3

In the above-described embodiments, a configuration is shown in which the smoothing process is performed so that the smoothing degree of the Y component is stronger than those of the C, M, and K components. However, the smoothing process may be performed so that the smoothing degree becomes strong in an order of (1) the Y component, (2) the minimum angle color component (the C component in the embodiments), and (3) the M and K components. In this manner, since the smoothing degree of the C component having a large influence on the occurrence of the moire of the Y component becomes strong, it is possible to further suppress the moire involved with the Y component from being noticed.

### D-4. Modified Example 4

In the above-described embodiments, the image data ORG is allowed to have multi-levels by performing the resolution converting process on the input image data ORG (Step S420) as the halftone data printing process shown in FIG. 4. However, in the case where the resolution of the input image data ORG is equal to the output resolution of the printer 200, the resolution converting process is not essential. In this case, the multi-level data may be created by performing the smoothing process on the image data ORG as the binary data (Step S440). In this case, the smoothing process is performed on all color components, the smoothing degree for the Y component may be set to be relatively strong. Likewise, the smoothing process may be performed on the binary halftone data, or may be performed on the multi-level halftone data.

### D-5. Modified Example 5

In the above-described embodiments, as the configuration of the smoothing process for the K component, a configuration is shown in which the smoothing process having a relatively weaker than that of the Y component is performed or the smoothing process is not performed. However, the smoothing degree for the K component may be arbitrarily set. For example, the smoothing degrees for the K component and the Y component may be equal, and the smoothing process having the smoothing degree stronger than that of the Y component may be performed on the K component. This is because the K component is noticed and has a relative large influence on the moire. In addition, in the case of the K component, it is necessary to consider other factors such as repeatability of the character other than the moire. Even in this case, it is possible to obtain the advantage of suppressing the moire involved with the Y component from being noticed to a certain degree.

### D-6. Modified Example 6

In the above-described embodiments, in the printing system 10 (the extensive printing apparatus) including the computer 100 and the printer 200, a configuration is adopted in which the computer 100 performs the processes in Step S410 to Step S460 of the halftone data printing process shown in FIG. 4, and the printer 200 performs the process in Step S470. However, a part or all of the processes from Step S410 to Step S460 may be performed by one of the computer 100 and the printer 200.

### D-7. Modified Example 7

In the above-described embodiments, the printing system 10 is shown which performs a printing process of the halftone image data including four colors C, M, Y, and K. However, the color components of the halftone image data input to the printing system 10 are not limited to include C, M, Y, and K, but may include at least four arbitrary colors. In this case, the process for the Y component according to the above-described embodiments may be performed on the color component having the highest luminance among the color components of the halftone image data, that is, the color component which is the most hardly noticed.

### D-8. Modified Example 8

In the above-described embodiments, the printing system 10 is shown which performs the printing process of the halftone image data including three color components of the C, M, and Y. However, instead of the color components of the C, M, and Y, the input halftone image data may include the color components of red R, green G, and blue B (hereinafter, simply referred to as R, G, and B) as complementary color of the C, M, and Y.

In this case, the smoothing process for the C, M, and Y according to the above-described embodiments may be performed on the R, G, and B as the complementary color corresponding thereto. For example, the smoothing process may be performed on the R, G, and B components so that the smoothing degree for the B component is relatively stronger than those of the R and G components. Between the color components of the C, M, and Y and the color components of the R, G, and B, the following equations (1) to (3) are satisfied, for example, in the case where the grayscale value is in the range of 0 to 255. Accordingly, to perform the smoothing process on the C, M, and Y components has a meaning that the smoothing process is performed on the R, G, and B components as the complementary color corresponding thereto. Even in this case, it is possible to obtain the above-described advantage.

R=255−C (1)

G=255−M (2)

B=255−Y (3)

As the halftone image data including the color components of the R, G, and B, for example, image data obtained by reading a halftone offset printing object through an image scanner or the like may be used. Accordingly, it is possible to very appropriately copy the halftone printing object by applying the printing system 10 to a so-called multi-functional device including a copy function, a printer function, a scanner function, and the like.

Likewise, the C, M, and Y of the halftone image data according to the above-described embodiments may be understood as the extensive C, M, and Y including the complementary color thereof. In addition, in the case where the halftone image data is formed by the R, G, and B, the above-described color converting module 35 converts the R, G, and B as the color components of the image data ORG subjected to the smoothing process into colors of color components C, M, Y, K, Lc, and Lm which can be displayed by the printer 200. In addition, the printing system 10 may have a configuration in which the color converting table LUT is stored for each color component of the supposed input data, and the used color converting table LUT is changed in accordance with the color component of the input data.

### D-9. Modified Example 9

In the above-described embodiments, a configuration is shown in which the printing system 10 receives the binary halftone image data and performs the printing process thereof, but a configuration may be adopted in which the printing system 10 is able to perform the printing process of the image data other than the halftone image data, for example, the multi-level image data such as a photo image. For example, a configuration may be adopted in which the printing system 10 includes a printing unit for determining whether the input image data is halftone image data, the process for the input image data is selected on the basis of the determination result, and the printing process is performed.

In this case, a configuration may be adopted in which the printing system 10 performs the above-described halftone data printing process when the determination unit determines that the input data is the halftone image data, and performs the normal printing process when the determination unit determines that the input data is not the halftone image data. Since the general printing process is a method which has been used for some time so as to perform a printing process on the image data other than the halftone image data, the detailed description thereof is omitted. However, for example, a process may be performed in which the smoothing process (Step S440) is omitted from the printing process shown in FIG. 4, or the substantially same printing process may be performed on each color component instead of the smoothing process in Step S440.

In this case, a configuration may be adopted in which the determination unit receives the type of the image data input by the user through a user interface, the printing mode in accordance to the type of the image data selected by the user, or the like, and determines the halftone image data. Accordingly, since it is possible to perform the determination just by receiving the user's command, it is possible to rapidly perform the printing process.

Alternatively, a configuration may be adopted in which the determination unit automatically determines whether the input data is the halftone image data. Since the automatic determination technology is a generally known technology, the detailed description is omitted. However, for example, a method may be used which detects a peak pixel having a grayscale value larger than that of the peripheral pixel by a predetermined degree, and determines whether the input data is the halftone image data on the basis of a ratio of the peak pixel with respect to the entire pixels. Alternatively, a method may be used which calculates an autocorrelation coefficient of a predetermined pixel block unit by using a fact that the halftone dot has a predetermined period, and determines whether the input data is the halftone image data on the basis of the value. Accordingly, since it is not necessary for the user to input the type of the input data, it is possible to improve the user's convenience.

As described above, the exemplary embodiments of the invention have been described, the constituents other than the constituents described in the independent claim among the constituents according to the embodiments of the invention are additional constituents, and may be appropriately omitted. In addition, the invention is not limited to the embodiments, but may be, of course, modified into various forms without departing from the scope not departing from the spirit of the invention. For example, the invention is not limited to the serial-type ink jet printer according to the above-described embodiments, but may be applied to an ink jet line printer. Further, the invention may be realized by a printing method, a program, a storage medium, or the like in addition to the configuration of the printing apparatus.

What is claimed is:

1. An ink jet printing apparatus capable of printing halftone image data representing a halftone image including at least color components of cyan, magenta, and yellow, the ink jet printing apparatus comprising:
an input unit which is used to input the halftone image data;
a smoothing unit which creates smoothing image data by performing a smoothing process only on the yellow component in the halftone image data or performing a smoothing process having a smoothing degree relatively stronger than those of other color components on the yellow component; and
a printing control unit which controls execution of a printing process on the basis of the smoothing image data.

2. The ink jet printing apparatus according to claim 1, further comprising:
a character detection unit which detects character data forming a character portion of the image represented by the halftone image data,
wherein the smoothing unit performs the smoothing process by excluding the character data detected by the character detection unit from a target of the smoothing process.

3. The ink jet printing apparatus according to claim 1, further comprising:
an edge detection unit which detects edge data forming an edge portion of the image represented by the halftone image data,
wherein the smoothing unit performs the smoothing process by excluding the edge data detected by the edge detection unit from a target of the smoothing process.

4. The ink jet printing apparatus according to claim 1,
wherein the smoothing unit changes a smoothing degree for the target pixel in accordance with an area ratio of a halftone dot in a peripheral pixel of the target pixel of the smoothing process.

5. The ink jet printing apparatus according to claim 4,
wherein the smoothing unit allows the smoothing degree for the yellow component of the target pixel to be relatively strong when the area ratio is within an intermediate degree of a predetermined range.

6. The ink jet printing apparatus according to claim 1,
wherein the smoothing unit changes a smoothing degree for the target pixel in accordance with a magnitude of a grayscale value of each color component in a peripheral pixel of the target pixel of the smoothing process.

7. The ink jet printing apparatus according to claim 6,
wherein the smoothing unit allows the smoothing degree for the yellow component of the target pixel to be relatively strong when a grayscale value of a minimum angle color component is larger than a predetermined value, the minimum angle color component being a color component having the smallest screen angle difference with respect to the yellow component among the yellow component in the peripheral pixel and/or the color components of the halftone image data.

8. The ink jet printing apparatus according to claim 1,
wherein the smoothing unit performs the smoothing process of the yellow component at a smoothing degree randomly selected from a plurality of types of predetermined smoothing degrees.

9. The ink jet printing apparatus according to claim 1,
wherein the smoothing unit performs the smoothing process having a smoothing degree relatively stronger than those of other color components on the yellow component, and
wherein the smoothing unit allows a smoothing degree of the smoothing process performed on a minimum angle color component to be relatively stronger than that of a color component obtained by excluding the minimum angle color component from the other color components, the minimum angle color component being a color component having the smallest screen angle difference with respect to the yellow component among the color components of the halftone image data.

10. The ink jet printing apparatus according to claim 1, further comprising:
a multi-level and resolution converting unit which creates conversion image data by converting the input halftone image data into multi-levels and converting a resolution of the halftone image data into an output resolution of the printing apparatus,
wherein the smoothing unit treats the conversion image data as the halftone image data to be subjected to the smoothing process.

11. A printing method of printing halftone image data representing a halftone image including at least color components of cyan, magenta, and yellow by using an ink jet printing apparatus, the printing method comprising:
inputting the halftone image data;
creating smoothing image data by performing a smoothing process only on the yellow component in the halftone image data or performing a smoothing process having a smoothing degree relatively stronger than those of other color components on the yellow component; and
performing a printing process by using the ink jet printing apparatus on the basis of the smoothing image data.
